(19) United States
(12) Patent Application Publication
(10) Pub. No.: US 2005/0060373 A1
(43) Pub. Date: Mar. 17, 2005

(54) Method and apparatus for fast communication with symbol linked object based system

(75) Inventor: Oliver K. Ban, Austin, TX (US)

Correspondence Address: International Business Machines;Intellectual Property Law, 11400 Burnet Road, Austin, TX, 78758, US

(73) Assignee: International Business Machines Corporation, Armonk, NY (US)

(21) Appl. No.: 10/660,008

(22) Filed: Sep. 11, 2003

(51) Int. Cl. G06F 15/16

(52) U.S. Cl. 709/206

(57) ABSTRACT

A method and apparatus for fast communication with a symbol linked object based system is useful in allowing a user to maintain control over the user's system when receiving an E-mail with a large attachment. The current art requires selecting and downloading an E-mail attachment to determine its size, which can result in a time consuming transfer of unwanted data to the user's system and causes the user to lose control of the system during the lengthy downloading process. The present invention allows separate files to be created and stored with the E-mail attachment while converting information about the size of the attachment into a set of symbols linked to the attachment sent to the E-mail recipient with the E-mail. The recipient can then determine whether to select, download or delete the attachment to which the symbols are linked.

### TECHNICAL FIELD

The present invention relates to electronic mail (E-mail) messages transmitted over communication networks such as the World Wide Web (Web) to display terminals, and particularly to large attachments to the E-mail messages.

### BACKGROUND OF RELATED ART

The past decade has been marked by a technological revolution driven by the convergence of the data processing industry with the consumer electronics industry. The effect has, in turn, driven technologies that have been known and available but relatively quiescent over the years. A major one of these technologies is the Internet of Web related distribution of documents. The Web or Internet, which had quietly existed for over a generation as a loose academic and government data distribution facility, reached, “critical mass” and commenced a period of phenomenal expansion. With this expansion, businesses and consumers have direct access to all matter of documents and media through the Web. Also, as a result, of the rapid expansion of the Web, E-mail, which has been distributed for over 25 years over smaller private and specific purpose networks, has moved into distribution over the Web because of the vast distribution channels that are available.

The availability of extensive E-mail distribution channels has made it possible to keep all necessary parties in business, government and public organizations completely informed of all transactions that they need to know about at almost nominal costs. Such communication can also include large attachments that are time consuming to download, which causes a receiving terminal to lose control of its terminal while the applications and the channel are finishing the downloading process. Currently, a user of the receiving terminal is not notified of the size of an attachment before beginning to download it.

### SUMMARY OF THE PRESENT INVENTION

The present invention provides a method and apparatus for fast communication over the Web via E-mails with large attachments. The present invention allows a user in a communication network for E-mail distribution between data processor controlled interactive display terminals, including a sending terminal and a receiving terminal, to determine the size of an E-mail attachment before selecting and downloading the attachment. The sending terminal stores data as a body and an attachment for sending with the E-mail. The sending terminal handshakes with the receiving terminal and converts the data in the sending terminal into a set of symbols that contain information regarding the size of an object to which it is linked. Then the symbols are transmitted from the sending terminal to the receiving terminal without transferring the data objects to which they correspond, allowing a user to determine the size of the data objects before selecting, downloading, or deleting the data objects.

The present invention is particularly useful to users of a computer system who receive E-mails with large attachments who want to maintain control of their systems while determining whether to select, download, or delete E-mail attachments.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a data processing system including a central processing unit and network connections via a communications adapter that is capable of implementing the interactive display terminals, as well as servers in the Internet or Web E-mail distribution of this invention;

FIG. 2 is a generalized view of an E-mail distribution system in a Web or Internet that may be used in the practice of the present invention;

FIG. 3 is a diagrammatic illustration of an interactive display interface used for the writing of an E-mail document where the attachment is a set of symbols indicating the size of the attachment to which it is linked; and

FIG. 4 is an illustrative flowchart describing the setting up of the functions to store an attachment separately from its E-mail while converting it to a set of symbols indicating the size of the attachment linked to the attachment.

### DETAILED DESCRIPTION OF THE PREFERRED EMBODIMENT

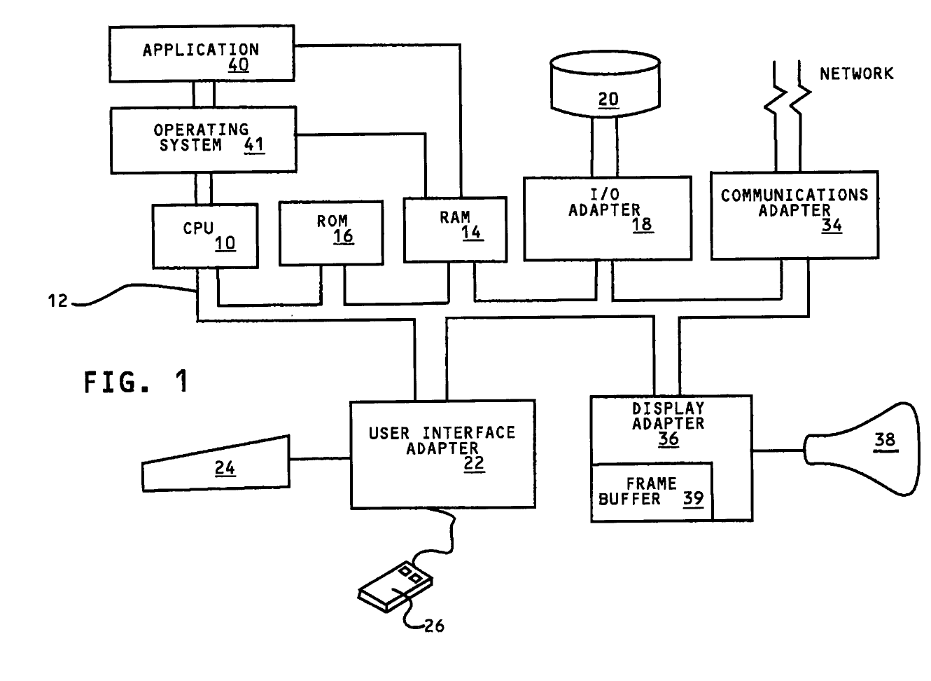

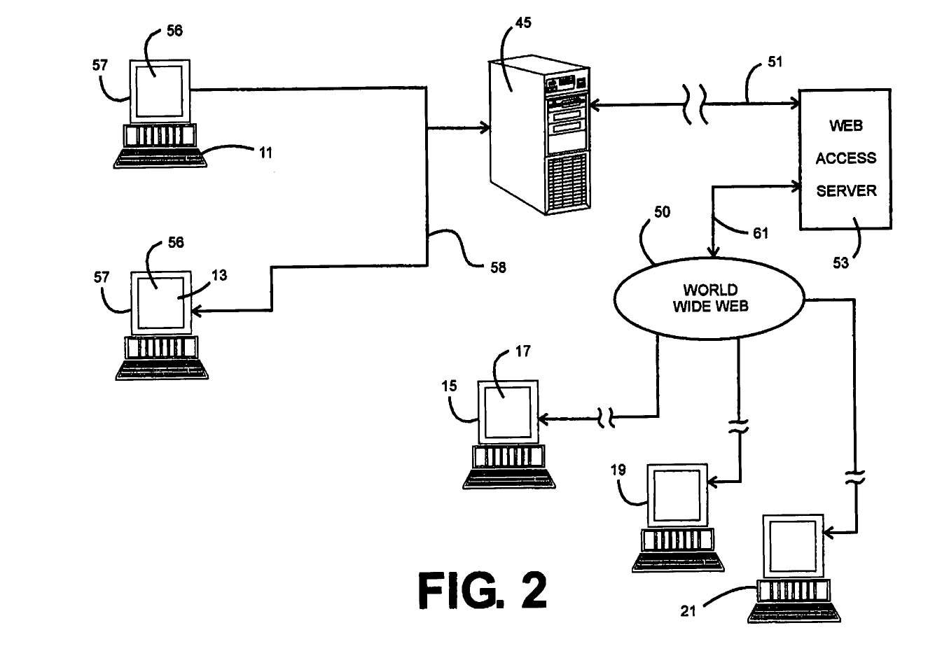

Referring to FIG. 1, a typical data processing system is shown which may function as the computer network terminal or Web station used conventionally as any of the sending or receiving Web stations for electronic mail transmission; the system shown is also illustrative of any of the server computers used for the Web E-mail distribution to be described in greater detail with respect to FIG. 2.

A central processing unit (CPU) 10, may be one of the commercial microprocessors in personal computers available from International Business Machines Corporation (IBM) or Dell Corporation; when the system shown is used as a server computer at the Web distribution site, to be subsequently described, then a workstation is preferably used, e.g. RISC System/6000™ (RS/6000) series available from IBM. The CPU 10 is interconnected to various other components by system bus 12. An operating system 41 runs on a CPU 10, provides control and is used to coordinate the functions of the various components of FIG. 1. Operating system 41 may be one of the commercially available operating systems such as IBM's AIX 5L™ operating system; Microsoft's Windows XP™; or Windows2000™, as well as other UNIX and AIX operating systems. Application programs 40, controlled by the system, are moved into and out of the main memory Random Access Memory (RAM) 14. These programs include the programs of the present invention for faster communication with a symbol linked object based system by separately storing an E-mail from its attachment in a sending terminal, transmitting information regarding the size of the attachment to a receiving terminal, and allowing the user of the receiving terminal to make an informed decision regarding whether to select, download or delete the attachment. Where the computer system shown functions as the receiving Web station, then any conventional Web browser application program, such as Microsoft's Internet Explorer™, will be available for accessing E-mail from the Web and for sending E-mail to the Web from the network station. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 communicates with the disk storage device 20. Communications adapter 34 interconnects bus 12 with the outside network enabling the computer system to communicate with other such computers over the Web or Internet. The latter two terms are meant to be generally interchangeable and are so used in the present description of the distribution network. I/O devices are also connected to system bus 12 via user interface adapter 22 and display adapter 36. Keyboard 24 and mouse 26 are all interconnected to bus 12 through user interface adapter 22. It is through such input devices that the user at a receiving station may interactively relate to the Web in order to access Web documents. Display adapter 36 includes a frame buffer 39, which is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

Before going further into the details of specific embodiments, it will be helpful to understand from a more general perspective the various elements and methods that may be related to the present invention. Since a major aspect of the present invention is directed to E-mail documents transmitted over networks, an understanding of networks and their operating principles would be helpful. We will not go into great detail in describing the networks to which the present invention is applicable. Reference has also been made to the applicability of the present invention to a global network, such as the Internet or Web. For details on Internet nodes, objects and links, reference is made to the text, Mastering the Internet, G. H. Cady et al., published by Sybex Inc., Alameda, Calif., 1996. The Internet or Web is a global network of a heterogeneous mix of computer technologies and operating systems. Higher level objects are linked to the lower level objects in the hierarchy through a variety of network server computers. E-mail is distributed through such a network.

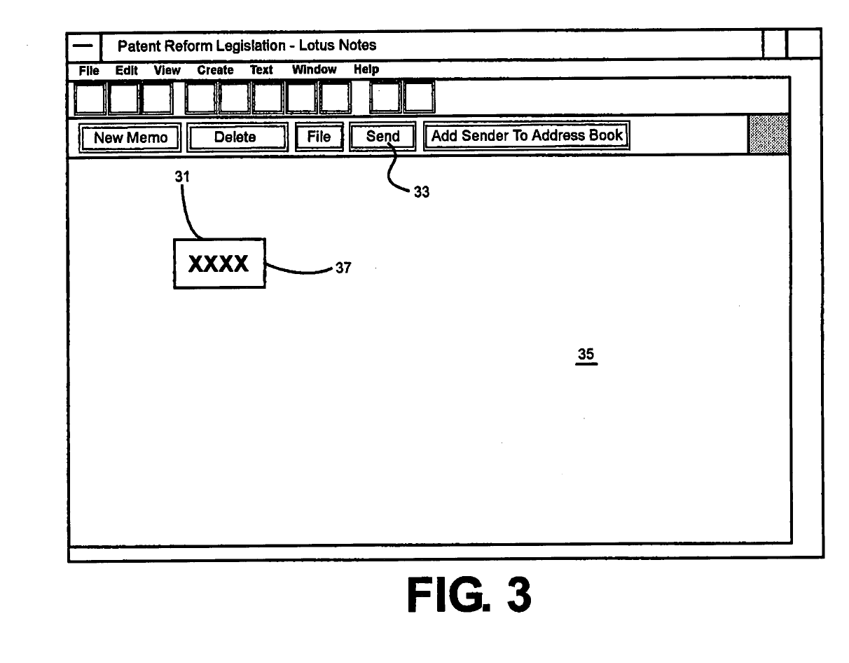

A generalized diagram of a portion of the Web for illustration of the E-mail distribution system of the present invention is shown in FIG. 2. The computer controlled display terminals 11 and 13 have displays 57 upon which E-mail documents 56 may be created by senders and displayed. Terminals 11 and 15 may be implemented by the computer system set up in FIG. 1, and connection 58 (FIG. 2) is the network connection shown in FIG. 1. For purposes of the present embodiment, terminals 11 and 13 serve as a Web display station for the sending of E-mail via the display interfaces to be described with respect to FIGS. 3 through 6 via Web browser programs. Reference may be made to the above-mentioned Mastering the Internet, pp. 136-147, for typical connections between local display stations to the Web via network servers, any of which may b used to implement the system on which this invention is used. In the typical set up shown, terminals are connected via, for example, host dial connections (not shown) to server 45 provided by a Web Service Provider that in turn accesses the Web 50 via connection 51 to a Web access server 53 and connection 61. For the purpose of this embodiment, E-mail is created on either terminal 11 or 13, and sent over the Web 50 to receiving terminals 15, 19 or 21. A key to the invention is the separate storage at the sending terminal of the E-mail with information about its attachment, and the full attachment. This is illustrated on terminal 13 wherein the E-mail attachment is stored separately, e.g. in the form of a folder.

In FIG. 3 there is illustrated an E-mail document or letter 35 being created by a sender as shown in FIG. 2, e.g. E-mail on sending terminals 13. The sender writes the message and attaches the attachment 31 or data object. When the sender clicks on the send button 33, the sending terminal 13 stores the attachment 31 in a separate file folder from the E-mail message being sent. The sending terminal 13 handshakes with the receiving terminal 11 and converts the attachment in the sending terminal 13 into a set of symbols 37 that contain information regarding the size of the attachment 31 to which it is linked. The sending terminal 13 is able to transmit these symbols 37 to the receiving terminal 11 without transferring the attachment 31 to which the symbols 37 are linked. The user of the receiving terminal 11 can determine from the information received in the symbols 37 the size of the attachment 31, and make a decision about whether to select, download or delete the attachment 31. This prevents a user of a receiving terminal 11 from losing control of the system by unknowingly selecting a large attachment that ties up the user's system for a long period of time.

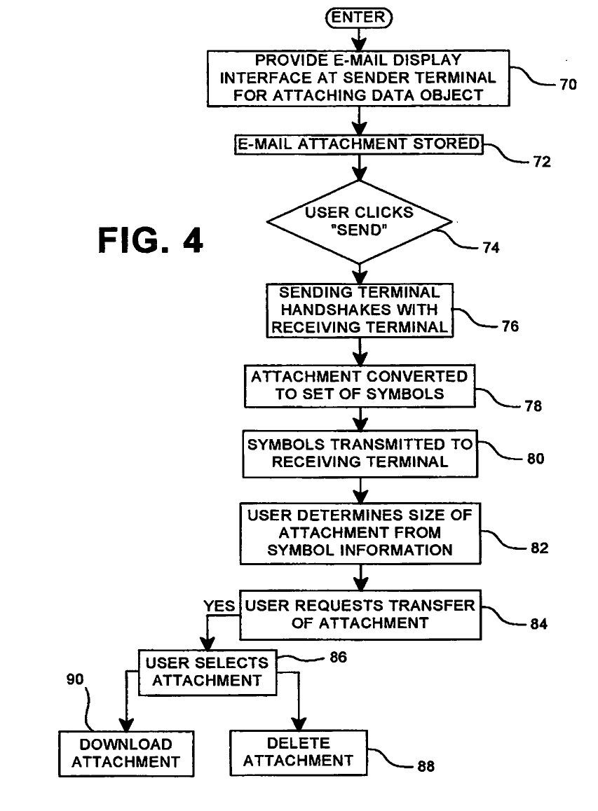

FIG. 4 is a flowchart showing the development of a process according to the present invention for enabling receivers of electronic mail with attachments to make an informed decision about whether to select, download or delete the attachment. At the display terminal of the E-mail sender there is provided an interface enabling the sender to attach an attachment or data object, step 70. The attachment is stored in the sending terminal, step 72. When the user of the sending terminal sends the E-mail with the attachment, step 74, the sending terminal handshakes with the receiving terminal, step 76. The attachment is converted into a set of symbols containing information about the size of the attachment to which the attachment is linked, step 78. The symbols are transmitted to the receiving terminal without transferring the attachment, step 80. The user of the receiving terminal determines from the symbols the size of the attachment, step 82. The attachments are transferred to the receiving terminal if requested by the user of the sending terminal, step 84. With regard to the attachment, the user of the receiving terminal can select, step 86, delete, step 88, or download, step 90.

One of the preferred implementations of the present invention is in application program 40 made up of programming steps or instructions resident in RAM 14, FIG. 1, of Web server computers during various Web operations. Until required by the computer system, the program instructions may be stored in another readable medium, e.g. in disk drive 20, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a Local Area Network (LAN) or a Wide Area Network (WAN), such as the Internet, when required by the user of the present invention. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

1. In a communication network for electronic mail distribution between data processor controlled interactive display terminals, a sending terminal comprising:
means for storing data as a body and an attachment for sending with electronic mail;
means for handshaking with a receiving terminal;
means for converting data in the sending terminal into a set of symbols that contain information regarding an object to which said data is linked;
means for transmitting symbols to the receiving terminal without transferring data objects; and
means for transferring the data objects in response to requests by the receiving terminal.

2. The electronic mail communication network of claim 1 further comprising:
means for determining from said symbols a size of their corresponding data object.

3. The electronic mail communication network of claim 2 further comprising means responsive to a request from the receiving terminal to select a data object from the sending terminal.

4. The electronic mail communication network of claim 3 further comprising means responsive to a request from the receiving terminal to download a data object from the sending terminal.

5. The electronic mail communication network of claim 3 further comprising means responsive to a request from the receiving terminal to delete a data object from the sending terminal.

6. The electronic mail communication network of claim 2 wherein:
said means for storing a symbol of said data object separately from its corresponding data object is a separate file folder at the sending terminal.

7. The electronic mail communication network of claim 6 further comprising means for separately transmitting said symbol from said data object.

8. A method for fast communication with a symbol linked object based system in a communication network for electronic mail distribution between data processor controlled interactive display terminals including the steps of:
storing, at a sending terminal, data as a body and an attachment for sending with electronic mail;
handshaking, by the sending terminal with a receiving terminal;
converting data in the sending terminal into a set of symbols that contain information regarding an object to which said data is linked;
transmitting symbols from the sending terminal to the receiving terminal without transferring data objects; and
transferring the data objects from the sending terminal in response to requests by the receiving terminal.

9. The electronic mail communication network of claim 8 further including the step of determining from said symbols a size of their corresponding data object.

10. The electronic mail communication network of claim 9 further including the step, responsive to a request from the receiving terminal, of selecting a data object from the sending terminal.

11. The electronic mail communication network of claim 10 further including the step, responsive to a request from the receiving terminal, of downloading a data object from the sending terminal.

12. The electronic mail communication network of claim 10 further including the step, responsive to a request from the receiving terminal, of deleting a data object from the sending terminal.

13. The electronic mail communication network of claim 9 wherein:
said storing of a symbol of said data object is stored separately from its corresponding data object is in a separate file folder at the sending terminal.

14. The electronic mail communication network of claim 13 further including the step of separately transmitting said symbol from said data object.

15. A computer program having code recorded on a computer readable medium for fast communication with a symbol linked object based system in a communication network for electronic mail distribution between data processor controlled interactive display terminals, a sending terminal comprising:
means for storing data as a body and an attachment for sending with electronic mail;
means for handshaking with a receiving terminal;
means for converting data into a set of symbols that contain information regarding an object to which said data is linked;
means for transmitting to the receiving terminal without transferring data objects; and
means for transferring the data objects in response to requests by the receiving terminal.

16. The electronic mail communication network of claim 15 further including means for determining from said symbols a size of their corresponding data object.

17. The electronic mail communication network of claim 16 further including means responsive to a request from the receiving terminal for selecting a data object from the sending terminal.

18. The electronic mail communication network of claim 17 further including means responsive to a request from the receiving terminal for downloading a data object from the sending terminal.

19. The electronic mail communication network of claim 17 further including means responsive to a request from the receiving terminal for deleting a data object from the sending terminal.

20. The electronic mail communication network of claim 16 wherein:
said means for storing a symbol of said data object separately from its corresponding data object is a separate file folder at the sending terminal.
